(19) United States
(12) Patent Application Publication
(10) Pub. No.: US 2020/0065664 A1
(43) Pub. Date: Feb. 27, 2020

(54) SYSTEM AND METHOD OF MEASURING THE ROBUSTNESS OF A DEEP NEURAL NETWORK

(71) Applicant: FUJITSU LIMITED, Kawasaki-shi (JP)

(72) Inventors: Ripon K. SAHA, Santa Clara, CA (US); Yuchi TIAN, San Jose, CA (US); Mukul R. PRASAD, San Jose, CA (US)

(73) Assignee: FUJITSU LIMITED, Kawasaki-shi (JP)

(21) Appl. No.: 16/109,404

(22) Filed: Aug. 22, 2018

(51) Int. Cl. G06N 3/08; G06N 5/02; G06F 21/56

(52) U.S. Cl. CPC G06N 3/08; G06F 2221/034; G06F 21/566; G06N 5/02

(57) ABSTRACT

A method of evaluating the robustness of a Deep Neural Network (DNN) model. The method includes obtaining a set of training data-points correctly predicted by the DNN model and obtaining a set of realistic transformations of the set of training data-points correctly predicted by the DNN model, where the set of realistic transformations corresponding to additional data-points within a predetermined mathematical distance from each of a training data-point of the set of training data-points. The method also includes creating a robustness profile corresponding to whether the DNN model accurately predicts an outcome for the additional data-points of the set of realistic transformations and generating a robustness evaluation of the DNN model based on the robustness profile.

### FIELD

The embodiments discussed in the present disclosure are related to Deep Neural Networks and systems and methods of measuring the robustness thereof.

### BACKGROUND

Deep Neural Networks (DNNs) are increasingly being used in a variety of applications. Despite the recent popularity, recent research has shown that DNNs are vulnerable to noise in the input. More specifically, even a small amount of noise injected into the input of the DNN can result in a DNN, which is otherwise considered to be high-accuracy, returning inaccurate predictions.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method of evaluating the robustness of a Deep Neural Network (DNN) model including obtaining a set of training data-points correctly predicted by the DNN model, obtaining a set of realistic transformations of the set of training data-points correctly predicted by the DNN model, the set of realistic transformations corresponding to additional data-points within a predetermined mathematical distance from each of a training data-point of the set of training data-points, creating a robustness profile corresponding to whether the DNN model accurately predicts an outcome for the additional data-points of the set of realistic transformations, and generating a robustness evaluation of the DNN model based on the robustness profile.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to evaluating the robustness of a Deep Neural Network (DNN) model;

FIG. 2 illustrates an example computing system that may be configured to evaluate the robustness of a DNN model;

FIG. 3 is a conceptual illustration of the difference between a robustness and an accuracy of a DNN model;

FIG. 4 is an illustration of how decreased robustness in a DNN model can result in errors;

FIG. 5 is a graph illustrating decreased accuracy due to increased amount of perturbation applied to the inputs of a DNN model;

FIG. 6 is a flowchart of an example method of evaluating two different DNN models according to robustness;

FIG. 7 is a flowchart of an example method of evaluating the robustness of a DNN model, in the region containing a given input point that the DNN is evaluating, and generating a confidence measure on the DNN's prediction on the said input based on the aforementioned robustness analysis;

FIG. 8 is a flowchart of another example method of evaluating a DNN model according to robustness;

FIGS. 9A and 9B are flowcharts of an example method of creating a point-wise perturbation-distance classification distribution of a DNN model based on a domain-specific set of parameterized transforms according to an example method;

FIG. 10 is a flowchart of an example method of calculating a robustness profile of a DNN model according to an example method;

FIG. 11 is a flowchart of an example method of identifying robustness holes in a DNN model according an example method;

FIG. 12 is a graph illustrating an example of a robustness evaluation of a DNN model; and

FIG. 13 is an example of an output which may be generated to illustrate identified robustness holes of a DNN model.

### DESCRIPTION OF EMBODIMENTS

Some embodiments described in the present disclosure relate to methods and systems of measuring the robustness of Deep Neural Networks (DNNs). A DNN is an artificial neural network (ANN) which generally includes an input layer and an output layer with multiple layers between the input and output layers. As the number of layers between the input and output increases, the depth of the neural network increases and the performance of the neural network is improved.

The DNN finds the correct mathematical manipulation to turn the input into the output, whether it be a linear relationship or a non-linear relationship. The network moves through the layers calculating the probability of each output. Each mathematical manipulation as such is considered a layer, and complex DNN have many layers, hence the name “deep” networks.

Deep Neural Networks (DNNs) are increasingly being used in a variety of applications. Examples of a few fields of application include autonomous driving, medical diagnostics, malware detection, image recognition, visual art processing, natural language processing, drug discovery and toxicology, recommendation systems, mobile advertising, image restoration, and fraud detection. Despite the recent popularity and clear utility of DNNs in a vast array of different technological areas, recent research has shown that DNNs are vulnerable to noise in the input, which can result in inaccurate predictions and erroneous outputs. In the normal operation of a DNN, a small amount of noise can cause small perturbations in the output, such as an object recognition system mischaracterizing a lightly colored sweater as a diaper, but in other instances, these inaccurate predictions can result in significant errors, such as an autonomous automobile mischaracterizing a school bus as an ostrich.

In order to create a DNN which is more resilient to such noise and results in fewer inaccurate predictions, an improved system of adversarial testing with an improved ability to find example inputs which result in inaccurate predictions which cause the DNN to fail or to be unacceptably inaccurate is disclosed. One benefit of finding such example inputs may be the ability to successfully gauge the reliability of a DNN. Another benefit may be the ability to use the example inputs which result in inaccurate predictions to “re-train” or improve the DNN so that the inaccurate predictions are corrected.

Embodiments of the present disclosure are explained with reference to the accompanying drawings.

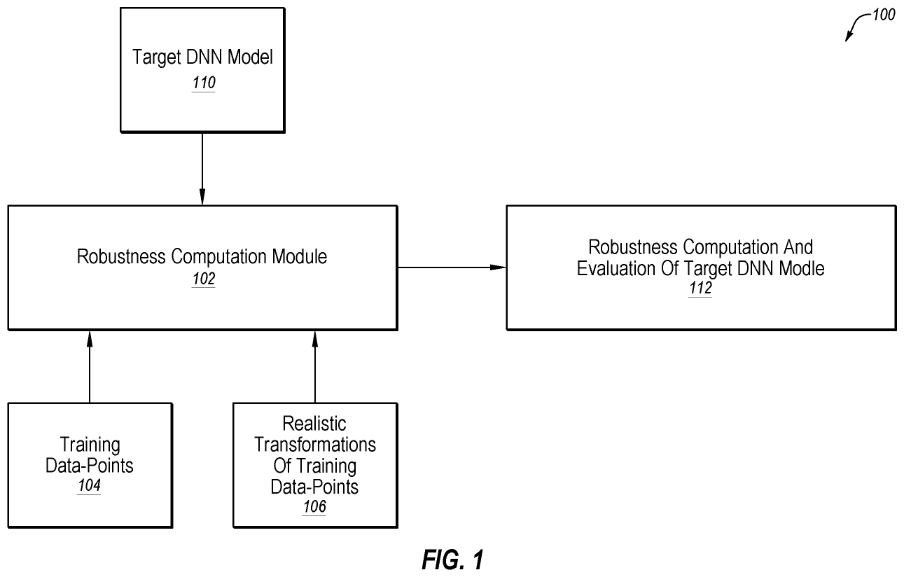

FIG. 1 is a diagram representing an example environment 100 related to evaluating the robustness of a DNN model, arranged in accordance with at least one embodiment described in the present disclosure. The environment 100 may include a robustness computation module 102 configured to analyze a target DNN model for robustness so as to provide a robustness computation and evaluation of the target DNN model 112. As is also described more fully below, the robustness computation module 102 utilizes a set of training data-points 104 and realistic transformations of the training points 106 to evaluate the robustness of the DNN model 110. Further, the robustness computation module 102 may also be configured to output identified robustness holes (not shown in FIG. 1), which may include one or more identified points where the target DNN model 110 fails to accurately predict outcomes within a predetermined degree of reliability.

The DNN model 110 being evaluated may include electronic data, such as, for example, the software program, code of the software program, libraries, applications, scripts, or other logic or instructions for execution by a processing device. More particularly, the DNN model 110 may be a part of a broader family of machine learning methods or algorithms based on learning data representations, instead of task-specific algorithms. This learning can be supervised, semi-supervised, or unsupervised. In some embodiments, the DNN model 110 may include a complete instance of the software program. The DNN model 110 may be written in any suitable type of computer language that may be used for performing the machine learning. Additionally, the DNN model 110 may be partially or exclusively implemented on specialized hardware, rather than as a software program running on a computer.

The robustness computation module 102 may include code and routines configured to enable a computing device to perform one or more evaluations of the DNN model 110 to generate the robustness computation and evaluation. Additionally or alternatively, the robustness computation module 102 may be implemented using hardware including a processor, a microprocessor (e.g., to perform or control performance of one or more operations), a field-programmable gate array (FPGA), or an application-specific integrated circuit (ASIC). In some other instances, the robustness computation module 102 may be implemented using a combination of hardware and software. In the present disclosure, operations described as being performed by the robustness computation module 102 may include operations that the robustness computation module 102 may direct a corresponding system to perform.

Modifications, additions, or omissions may be made to FIG. 1 without departing from the scope of the present disclosure. For example, the environment 100 may include more or fewer elements than those illustrated and described in the present disclosure.

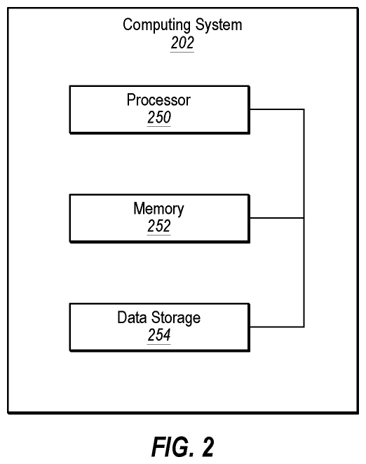

FIG. 2 illustrates a block diagram of an example computing system 202, according to at least one embodiment of the present disclosure. The computing system 202 may be configured to implement or direct one or more operations associated with an evaluation module (e.g., the robustness computation module 102). The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 250 may include any number of processors configured to, individually or collectively, perform or direct performance of any number of operations described in the present disclosure. Additionally, one or more of the processors may be present on one or more different electronic devices, such as different servers.

In some embodiments, the processor 250 may be configured to interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

For example, in some embodiments, the repair module may be included in the data storage 254 as program instructions. The processor 250 may fetch the program instructions of the repair module from the data storage 254 and may load the program instructions of the repair module in the memory 252. After the program instructions of the repair module are loaded into memory 252, the processor 250 may execute the program instructions such that the computing system may implement the operations associated with the repair module as directed by the instructions.

The memory 252 and the data storage 254 may include computer-readable storage media for carrying or having computer-executable instructions or data structures stored thereon. Such computer-readable storage media may include any available media that may be accessed by a general-purpose or special-purpose computer, such as the processor 250. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM)or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

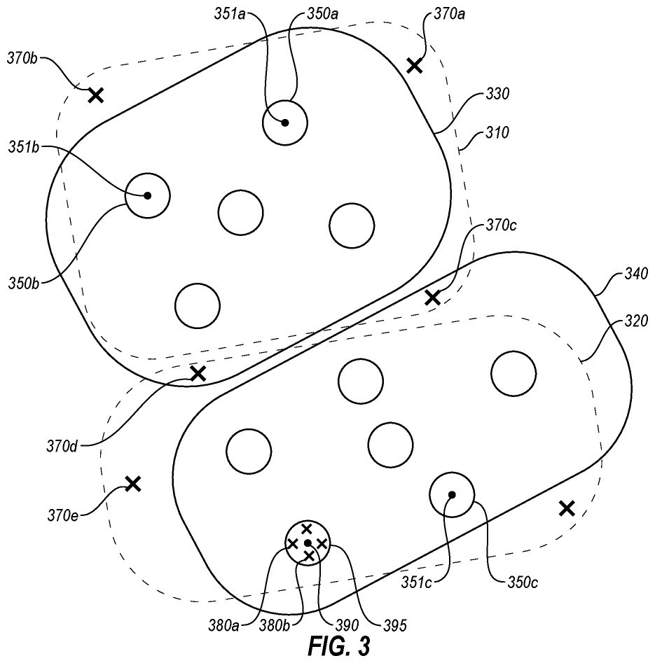

FIG. 3 is a conceptual illustration of robustness. As is shown in FIG. 3, for a first class 310 and a second class 320, a target DNN model 110 may generate a pair of predicted classes, including a first predicted class 330 and a second predicted class 340, which are an attempt by the target DNN model 110 to accurately predict a series of outcomes for the first class 310 and second class 320. Typically, the target DNN model 110 develops the first predicted class 330 and second predicted class 340 by utilizing a series of training data-points 351a-351c. Generally, the accuracy of a target DNN model 110 is based on its ability to minimize adversarial instances or mis-classifications, such as the points 370a-370e, which are found in the areas where the first predicted class 330 and second predicted class 340 do not accurately predict the scope of the first class 310 and second class 320, respectively.

Because the training data-points 351a-351c are used to develop the target DNN model 110, there is an expectation that the DNN model 110 will be highly accurate at points near or within a predetermined distance to those training data-points 351a-351c. In this illustration, the areas within a predetermined distance to those training points 351a-351c are referred to as areas 350a-350c of training points 351a-351c. In reality, however, often the DNN model 110 can fail, even spectacularly, within an area of a training point. For example, in the conception shown in FIG. 3, despite the accuracy of training point 390, the DNN model 110 may inaccurately predict results for points 380a-380b, which are within the area 395 of the training point 390.

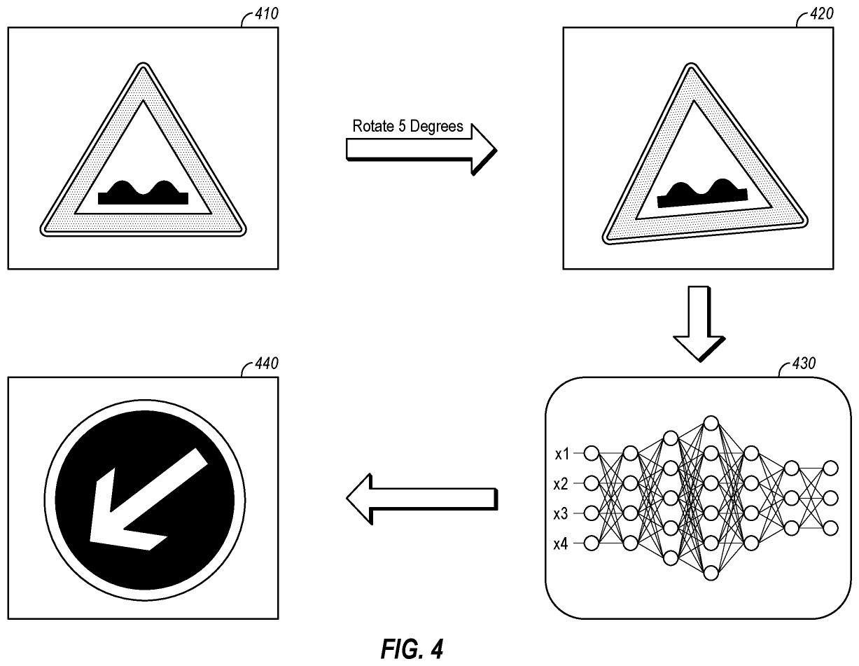

FIG. 4 in association with FIG. 3 illustrates how small noise or variation in points 380a-380b, which are within an area (such as the area 395 shown in FIG. 3) of a training point (such as the training point 390 shown in FIG. 3) may result in great inaccuracies in a target DNN model 110. In the example shown in FIG. 4, adversarial testing of a traffic sign using a popular and well-known image classification DNN model 110, known as the VGG16 model (herein referred to as “VGG16 DNN”), proposed by K. Simonyan and A. Zisserman from the University of Oxford in 2015, which generally achieves a 92.7% accuracy of an ImageNet dataset of over 14 million images belonging to 1000 different classes, is performed. In this example, a traffic sign 410 corresponding to a warning of upcoming speed-bumps or speed-breaks is used as the training point 390. A small variation in the traffic sign 410, such as the rotation of the traffic sign by 5°, resulting in the image 420, which is within the area 395 of predictable or expected noise for the training point 390 corresponding to the traffic sign 410 is used as input in the VGG16 DNN model 430, which is an example of a target DNN model 110, and the resulting prediction is grossly misclassified as an instance of image 440 corresponding to a different type of traffic sign, with the misclassification occurring with a high confidence level.

As may be understood, this small, predictable amount of variation, which may arise from the example traffic sign being improperly mounted on a pole, resulting in a slight skew of the traffic sign, may have significant results. This would be particularly true in applications where the image classification is utilized by an autonomous automobile which may fail to slow for the speed bumps or may direct the automobile in an incorrect direction.

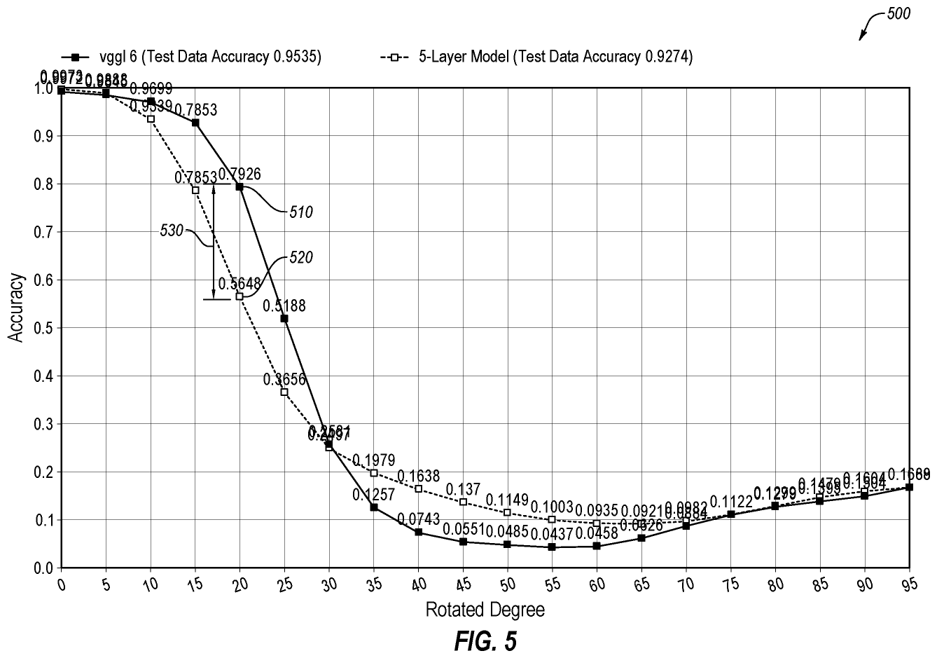

FIG. 5 further illustrates this principle. FIG. 5 illustrates the accuracy of two different target DNN models 110 in identifying the traffic sign 410 at various degrees of rotation, corresponding to increases in noise or realistic variations to a training point 390. One target DNN model 110 is the VGG16 DNN described above. The other target DNN model 110 shown in FIG. 5 is a 5-layer model, which is also known in the art. As is shown in FIG. 5, despite both models having high overall accuracy, 95% and 93% accuracy for the VGG16 and 5-layer, respectively, the two target DNN models 110 exhibit substantially different robustness profiles at various noise levels, corresponding to the different amounts of image rotation. For example, at 20° rotation, the two target DNN models 110 display 23% difference in accuracy.

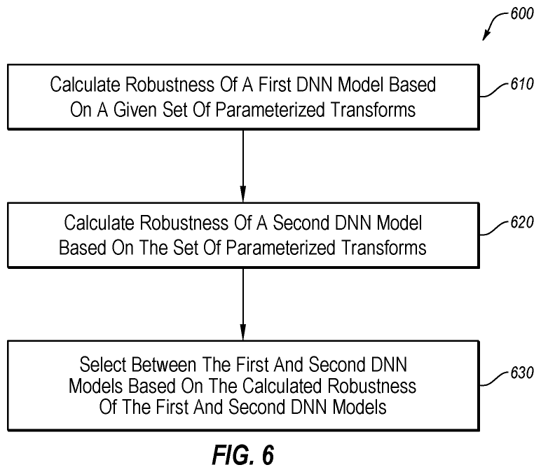

FIG. 6 is a flowchart of an example method 600 of calculating and evaluating the robustness of a first target DNN model and a second target DNN model (both of which can be generally depicted as a target DNN model 110 in FIG. 1), according to at least one embodiment described in the present disclosure. The method 600 may be performed by any suitable system, apparatus, or device. For example, the robustness computation module 102 of FIG. 1 or the computing system 202 of FIG. 2 (e.g., as directed by a robustness computation module) may perform one or more of the operations associated with the method 600 with respect to the target DNN model(s) 110. Although illustrated with discrete blocks, the steps and operations associated with one or more of the blocks of the method 600 may be divided into additional blocks, combined into fewer blocks, or eliminated, depending on the particular implementation.

At 610, the robustness of a first DNN model is evaluated using a given, domain-specific set of parametrized transforms, which are described more fully below. More particularly, in one embodiment, the parameterized transforms represent real-world sources of variation which approximate a realistic area within which to evaluate the robustness of a DNN model and which may correspond to predictable real-life variations to training data-points. This evaluation may result in the generation of a first robustness profile of the first DNN model, where the first robustness profile represents the average accuracy of prediction of the DNN model over a set of training data-points, as they are suitably perturbed, as a function of the distance of the perturbed point from the original training data-points.

At 620, the robustness of a second DNN model is evaluated using the same given, domain-specific set of parametrized transforms. This evaluation may result in the generation of a second robustness profile of the second DNN model.

At 630, a selection may be made between the first DNN model and the second DNN model based on the robustness profiles and/or the calculated robustness of the first and second DNN models.

The method 600 may improve the ability to properly evaluate and improve DNN models and their ability to effectively and efficiently perform machine learning.

Modifications, additions, or omissions may be made to the method 300 without departing from the scope of the present disclosure. For example, the operations of method 600 may be implemented in differing order. Additionally or alternatively, two or more operations may be performed at the same time. For example, the calculation of robustness of each of the first DNN model at 610 and the calculation of robustness of the second DNN model at 620 may be simultaneously performed. Furthermore, the outlined operations and actions are only provided as examples, and some of the operations and actions may be optional, combined into fewer operations and actions, or expanded into additional operations and actions without detracting from the essence of the disclosed embodiments.

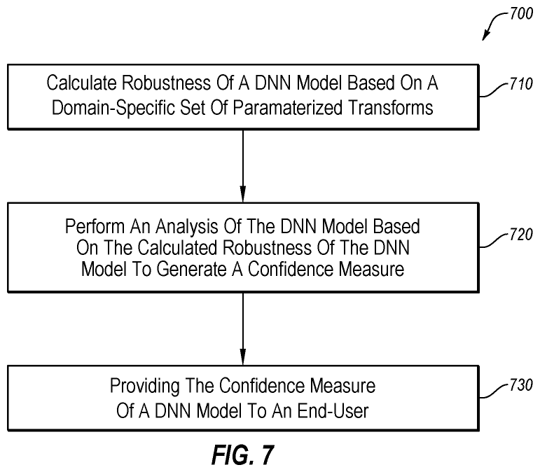

FIG. 7 is a flowchart of an example method 700 of calculating and evaluating the robustness of a target DNN model 110, according to at least one embodiment described in the present disclosure. As with the method 600, the method 700 may be performed by any suitable system, apparatus, or device. For example, the robustness computation module 102 of FIG. 1 or the computing system 202 of FIG. 2 (e.g., as directed by a robustness computation module) may perform one or more of the operations associated with the method 700 with respect to the target DNN model 110. Although illustrated with discrete blocks, the steps and operations associated with one or more of the blocks of the method 700 may be divided into additional blocks, combined into fewer blocks, or eliminated, depending on the particular implementation.

At 710, the robustness of the DNN model is calculated based on a domain-specific set of parameterized transforms, as is described in more detail below. This may include representing the aggregate robustness of the DNN model to generate a robustness profile which represents the average accuracy of prediction over all the training data-points used to generate the DNN model, where the training data-points are suitably perturbed from the original training data-points in manners which correspond to predictable variations, and which are represented as a function of the distance of the perturbed points from the original training data-points.

At 720, the calculated robustness of the DNN model and/or the robustness profile may be analyzed to generate a confidence measure corresponding to the DNN's model to be resilient to predictable variations from training data-points and resilience to noise. This confidence measure may be a function that maps each test input that the user might present to the model to a confidence value that indicates the likelihood of the model having robust predictive behavior in the neighborhood of this input point. At 730, the confidence measure may be used to compute and return to the user a robustness confidence value corresponding to a test input presented to the model by the end-user.

As may be understood, modifications, additions, or omissions may be made to the method 700 without departing from the scope of the present disclosure. Furthermore, the outlined operations and actions are only provided as examples, and some of the operations and actions may be optional, combined into fewer operations and actions, or expanded into additional operations and actions without detracting from the essence of the disclosed embodiments.

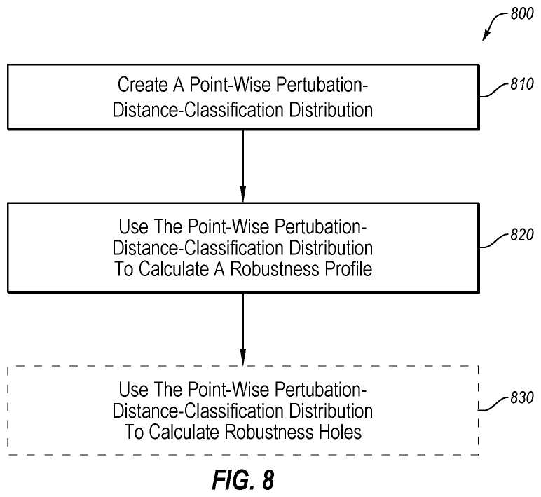

FIG. 8 is a flowchart of an example method 800 of calculating and evaluating the robustness of a target DNN model 110, according to at least one embodiment described in the present disclosure. It should be noted that a the robustness of a target DNN model 110 described herein is the ability of the DNN model 110 to correctly and accurately classify data-points that are small, realistic, and/or foreseeable variations of training data-points and/or other data points the DNN model 110 currently classifies correctly.

More particularly, in an ideally robust system, given a training data point ρ, which is currently correctly classified by the DNN model 110, the distance d(δ) is a function that captures the perceived or human similarity between two data-points. In this example, robustness R(ρ, δ), with respect to ρ and δ is the fraction of input data-points at distance δ that are correctly classified by the DNN model 110.

It should be noted that because there are a potentially infinite number of variations, there is potentially an infinite number of data-points which may be found within the distance δ from the data point ρ. In order to limit the number of realistic variations which may be found, and as is described more fully below, embodiments herein attempt to define and utilize a closed set of realistic transformations, which simulate situations or circumstances which are likely to occur in the natural world during the process of input data capture. As such, the set of transformations T={T₁, T₂, . . . Tₖ} are designed to simulate situations or circumstances which introduce realistic variations which are likely or most likely to occur.

For example, for image data there may be predictable or foreseeable differences in image capture variations such as camera angle, lighting conditions, artifacts in the optical equipment, or other imperfections in the image capturing process, such as motion blur, variance in focus, etc. These variations introduce realistic variations of an original subject image which may serve as a training data-point.

Given a set of parametrized transformations T={T₁(ρ₁), T₂(ρ₂), . . . Tₖ(ρₖ)} that yield realistic or parametric variations of the given data point (ρ), the point-wise robustness may be a function of T which may be used to compute a robustness measure R(ρ, δ, T), which computes robustness only the points produced by the parametrized transformations in T.

It should be noted that the L^{P}-norm is a metric that is used in the computer vision and imaging art to measure a distance between two images by measuring the difference between two vector in a given vector space. In some instances, embodiments herein may use the L²-norm in the pixel space of the images, or Euclidean norm or Sum of Squared Difference (SSD) to measure the distance between two images. This norm is defined as:)

∥x₁−x₂∥₂=\sqrt{Σᵢ(x₁ᵢ−x₂ᵢ)²}

where (x₁ᵢ−x₂ᵢ) denotes the distance between i^{th} pixels in the two images.

Returning to FIG. 8, it should be noted that the method 800 may be used as at least a portion of steps and operations shown as at least blocks 610 and 620 in FIG. 6 and block 710 in FIG. 7. Further, it should be appreciated that the method 800 may be performed by any suitable system, apparatus, or device. For example, the robustness computation module 102 of FIG. 1 or the computing system 202 of FIG. 2 (e.g., as directed by a robustness computation module) may perform one or more of the operations associated with the method 800 with respect to the target DNN model(s) 110. Although illustrated with discrete blocks, the steps and operations associated with one or more of the blocks of the method 800 may be divided into additional blocks, combined into fewer blocks, or eliminated, depending on the particular implementation.

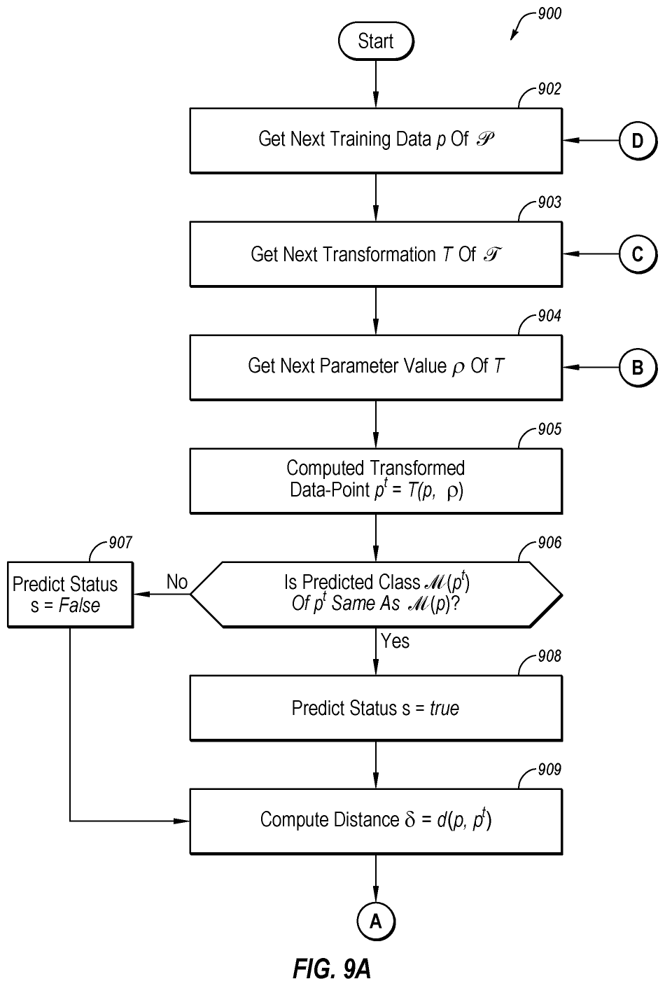

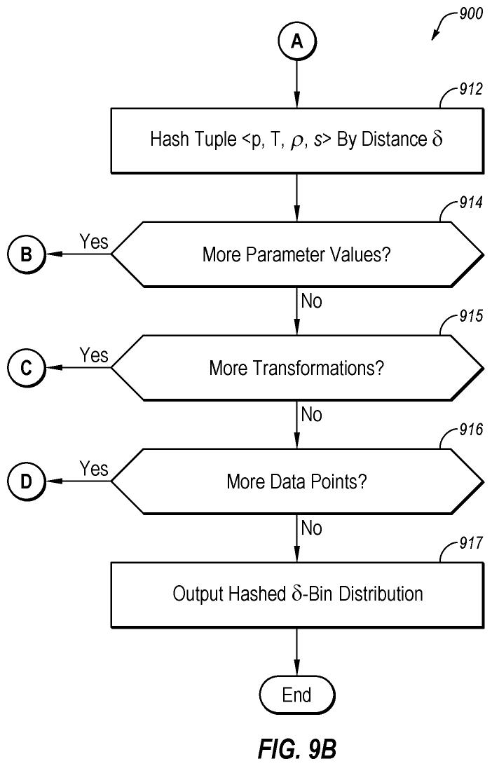

At 810, a point-wise perturbation-distance-calculation distribution is created. In one embodiment this is created according to the method 900 shown in FIG. 9, although it should be appreciated that other methods may be used. More particularly, for a target DNN model 110, represented as M, given a population of training data points P (shown as training data-points 104 in FIG. 1) and realistic transformations of training data points T={T₁, T₂, . . . Tₖ} (shown as realistic transformations of training data-points 106 in FIG. 1), a point-wise perturbation-distance-classification distribution is created.

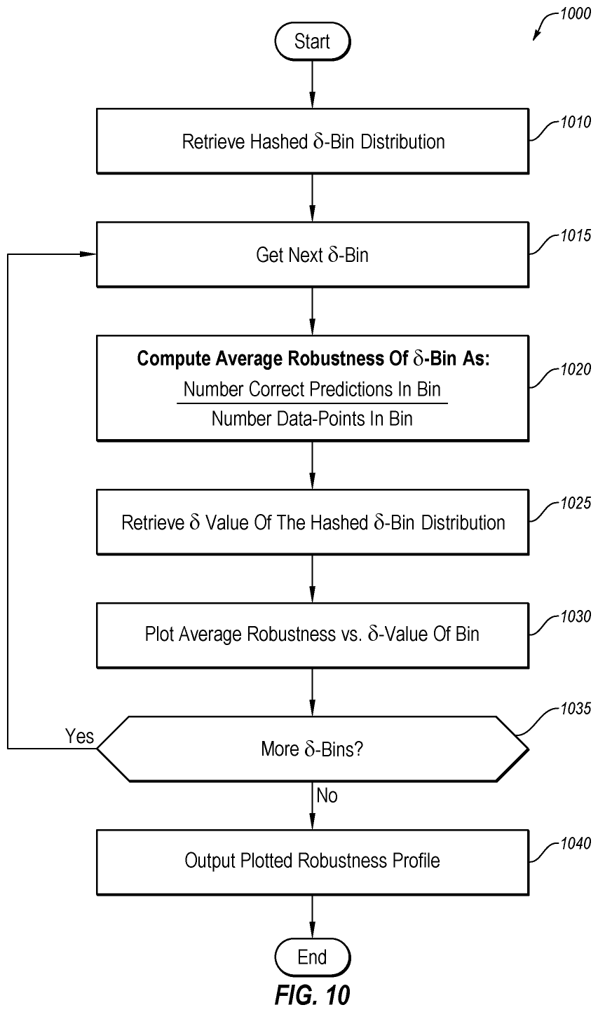

At 820, the point-wise perturbation-distance-classification distribution is used to calculate a robustness profile of the target DNN model 110. This is described more fully below, with one example illustrated as a block diagram of a method 1000 shown in FIG. 10. As may be understood, other methods may be used to create the robustness profile.

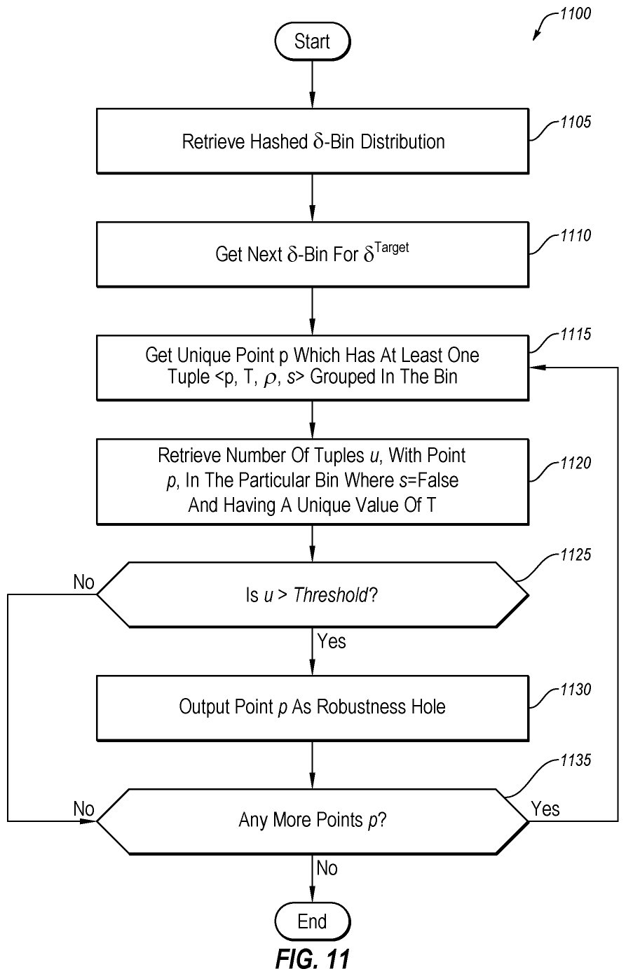

At 830, an optional process of using the point-wise perturbation-distance-classification distribution to identify robustness holes in the target DNN model 110. As is described more fully below, with one example illustrated as a block diagram of a method 1100 shown in FIG. 11, the point-wise perturbation-distance-classification distribution may be used to identify areas where the inaccuracy of the target DNN model 110 at a particular area of a training point is below a particular threshold of acceptability.

FIGS. 9A and 9B are block diagrams illustrating one example of a method 900 for creating the perturbation-distance classification distribution illustrated in 810 of FIG. 8. More particularly, for a target DNN model 110, represented as M, at 902, a population of training data points P (shown as training data-points 104 in FIG. 1) is obtained. Next, at 903, a set of realistic transformations of training data points T={T₁, T₂, . . . Tₖ} (shown as realistic transformations of training data-points 106 in FIG. 1) are obtained

At 904, a parameter value ρ of T is obtained. Then, at 905, the transformed data-point p^{t}=T(p, ρ). At 906 a determination is made as to whether the predicted class M(p^{t}) of p^{t} is the same as M(p). If not, then at 909, the prediction status s is set as being equivalent to “false.” If at 907, the determination is determined to be yes, then the method 900 proceeds to 908, where the prediction status s for the data point is set as being “true,” where the term s is equivalent to the value (true or false) of the equality comparison between the class M(p) of point p as predicted by the model M, and the class M(p^{t}) of the point p^{t} as predicted by the model M.

At 909, a distance δ=d(p, p^{t}) is calculated. At 912, a tuple <p, T, p, s> is hashed by distance δ. At 914, a determination is made as to whether there are additional parameter values to be evaluated. If so, the method 900 returns to 904. If there are not more parameter values to be evaluated, the method 900 determines at 915 if there are more transformations to be evaluated. If there are more transformations to be evaluated, the method 900 returns to 903. If there are not more transformations to be evaluated, the method 900 proceeds to 916, where a determination is made as to whether there are more data-points to be evaluated. If there are more data-points to be evaluated, the method 900 returns to 902. If there are not more data-points to be evaluated, the method 900 generates and outputs the hashed δ-bin distribution as a calculated perturbation-distance distribution.

FIG. 10 is a block diagram illustrating a method 1000 of computing and generating a robustness profile of a target DNN model 110. As may be understood, in one embodiment, FIG. 10 may be used in association with FIG. 8 as an example of a method of generating a robustness profile at 820. As may be understood, other methods may be used without departing from the scope of the intended invention.

At 1010, the method 1000 retrieves the hashed δ-bin distribution as a calculated perturbation-distance distribution. This may be the result of the method described as the method 900 shown in FIG. 9 and described above. At 1015, a δ-bin of the δ-bin distribution is retrieved. Each δ-bin has several hashed tuples <p, T, p, s> where the s field of the tuple denotes a point with a correct prediction if s=true and an incorrect prediction if s=false. At 1020, an average robustness of the δ-bin is calculated as:

$$\frac{\# of correct predictions in bin}{\# of data - points in bin}$$

At 1025 the δ value of the hashed δ-bin distribution is retrieved and at 1030, the average robustness vs. the δ-value of the bin is plotted.

At 1035, a determination of whether there are remaining δ-bin in the δ-bin distribution requiring evaluation is made. If so, then the method 900 returns to 915 and the next δ-bin is retrieved. If not, then the method 900 outputs the plotted or calculated robustness profile at 1040.

FIG. 11 is a block diagram illustrating a method 1100 of computing robustness holes in a DNN model 110 according to the embodiment illustrated as block 830 in FIG. 8. At 1105, the hashed δ-bin distribution is retrieved. At 1110, the δ-bin is retrieved corresponding to a given target value of δ^{target}. At 1115, a unique point p is retrieved which has at least one tuple <p, T, ρ, s> is grouped into this bin. At 1120, the number of tuples u, with point p, in the particular bin is retrieved which have s=false and a unique value of T, i.e., failing points under different transformations T.

At 1125 a determination is made as to whether u>a particular threshold. If so, the point p is output as an identified robustness hole at 1130. If not, then a determination is made at 1135 as to whether there are any more points p. If so, then the method 1100 returns to block 1115. If not, then the method 1100 ends with the outputted robustness holes having been identified.

As was previously described, the system and method herein calculate a point-wise robustness and/or an overall robustness of a DNN model 110, which may be used to differentiate between various DNN models for a given machine learning application. As may be understood, by providing the ability to calculate or quantify the robustness of a DNN model 110, enables a user to identify areas of the DNN model 110 which need improvement and/or to identify a particular DNN model 110 which is better suited to a particular application.

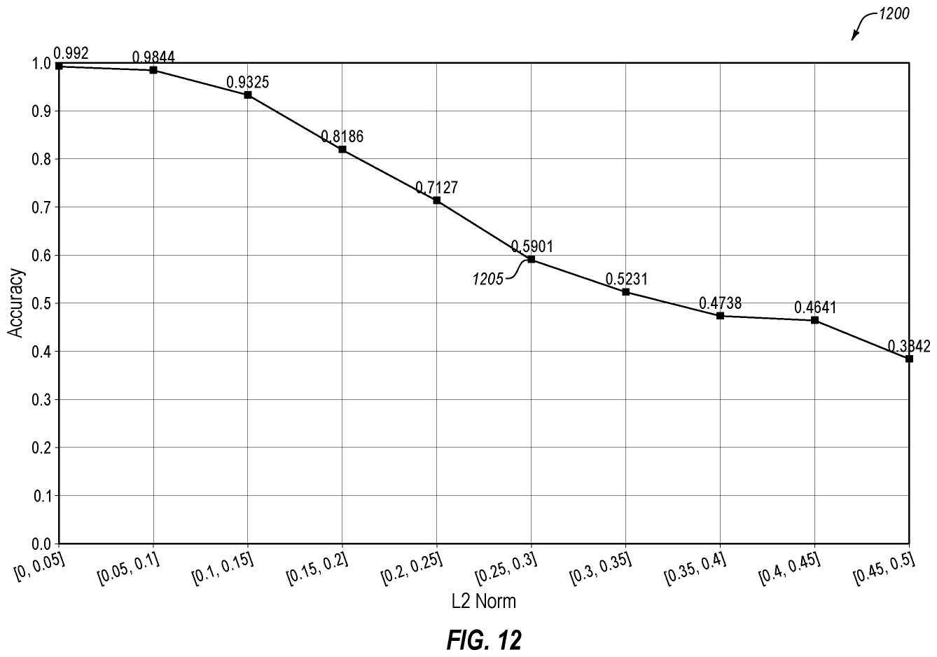

FIG. 12 is a graph 1200 of an example of a robustness profile of a DNN model 110. In the example shown in FIG. 12, the DNN model is the VGG16 model using a German Traffic Sign data set consisting of more than 50,000 images of German Traffic Signs and more than 40 image classes corresponding to different types of traffic signs. The robustness is measuring using the L²-norm is used as a distance measure as the realistic transformations of training data-points. In the graph 1200, the point 1205 illustrates that 41% of the points between δ=[0.25-0.30] in the L²-norm distance measurement were mis-classified despite the perceived accuracy of the VGG16 model.

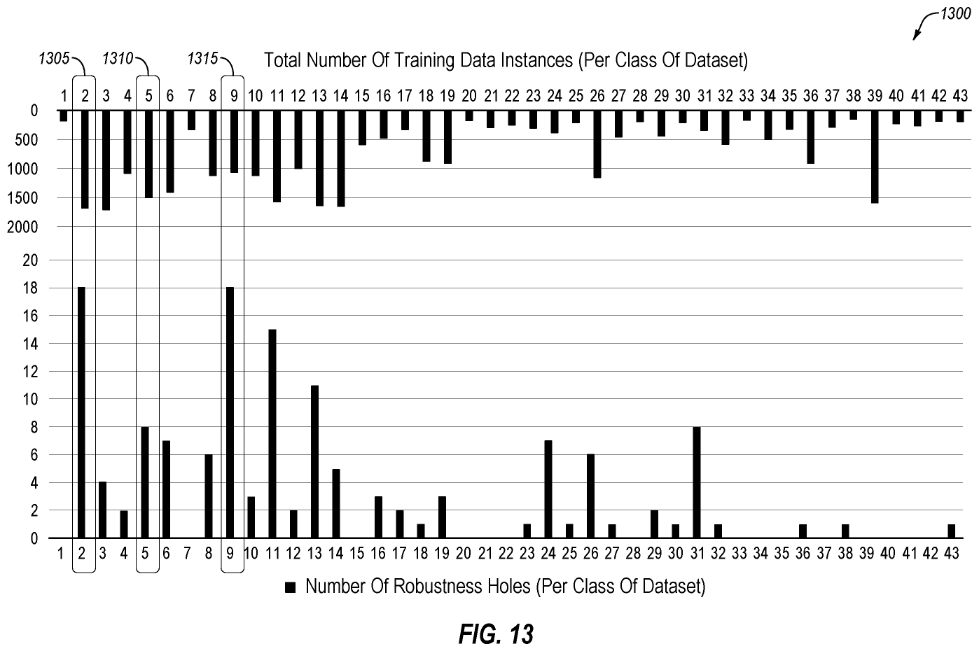

FIG. 13 is an example of an output 1300 which may be generated to identify various robustness holes for a particular model. In the example output 1300, it illustrates areas where the number of robustness holes exists (per class of dataset). In the output 1300, it is clearly shown that there are the greatest number of robustness holes in the second 1305 and ninth 1315 classes of a dataset. This indicates that those classes of the dataset need improvement as they are disproportionately erroneous, as compared to the fifth class 1310 of the dataset, which has a similar number of training data instances as in the second 1305 class of the dataset.

As may be understood, identifying classes of the DNN model 110 which need improvement may be used as a means for improving existing DNN models 110 or identifying areas of weakness of DNN models 110. Hence, the systems and methods described herein provide the ability to evaluate, quantify, and, in some instances, improve DNN models and provide more accurate machine learning.

As indicated above, the embodiments described in the present disclosure may include the use of a special purpose or general purpose computer (e.g., the processor 250 of FIG. 2) including various computer hardware or software modules, as discussed in greater detail below. Further, as indicated above, embodiments described in the present disclosure may be implemented using computer-readable media (e.g., the memory 252 or data storage 254 of FIG. 2) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of evaluating the robustness of a Deep Neural Network (DNN) model, the method comprising:
obtaining a set of training data-points correctly predicted by the DNN model;
obtaining a set of realistic transformations of the set of training data-points correctly predicted by the DNN model, the set of realistic transformations corresponding to additional data-points within a predetermined mathematical distance from each of a training data-point of the set of training data-points;
creating a robustness profile corresponding to whether the DNN model accurately predicts an outcome for the additional data-points of the set of realistic transformations; and
generating a robustness evaluation of the DNN model based on the robustness profile.

2. The method of claim 1, further comprising:
identifying a plurality of robustness holes in the DNN model corresponding to additional data-points where the DNN model is determined as inaccurately predicting the outcome of the additional data-points.

3. The method of claim 2, wherein the DNN model is an image classification model and the predetermined mathematical distance is a LP-norm used to measure a distance between two images by measuring the difference between two vectors in a given vector space.

4. The method of claim 2, wherein the robustness evaluation of the DNN model identifies a particular class of realistic transformations where there are identified robustness holes.

5. The method of claim 1, wherein the robustness evaluation of the DNN model comprises a graph illustrating the robustness at the additional data-points of the realistic transformations.

6. The method of claim 1, wherein the DNN model is a malware detection model, wherein the set of realistic transformations correspond to source code obfuscation transforms and the mathematical distance corresponds to a distance between a training-data point source code and additional data-points corresponding to potential malware code.

7. A method of evaluating a first Deep Neural Network (DNN) as compared to a second DNN in terms of robustness, the method comprising:
obtaining a set of training data-points correctly predicted by both the first DNN model and the second DNN model;
obtaining a set of realistic transformations of the set of training data-points correctly predicted by both the first DNN model and second DNN model, the set of realistic transformations corresponding to additional data-points within a predetermined mathematical distance from each of a training data-point of the set of training data-points;
creating a first robustness profile corresponding to whether the first DNN model accurately predicts an outcome for the additional data-points of the set of realistic transformations;
creating a second robustness profile corresponding to whether the second DNN model accurately predicts an outcome for the additional data-points of the set of realistic transformations;
generating a first robustness evaluation of the first DNN model based on the robustness profile;
generating a second robustness evaluation of the second DNN model based on the robustness profile; and
identifying whether the first DNN model or the second DNN model has greater robustness based on the first robustness evaluation and the second robustness evaluation.

8. The method of claim 7, further comprising:
identifying a plurality of robustness holes in each of the first and second DNN models corresponding to additional data-points where each of the respective first and second DNN models are determined as inaccurately predicting the outcome of the additional data-points.

9. The method of claim 8, wherein each of the first and second DNN models are image classification models and the predetermined mathematical distance is a L^{P}-norm used to measure a distance between two images by measuring the difference between two vectors in a given vector space.

10. The method of claim 8, wherein each of the first and second DNN models are malware detection models, and wherein the set of realistic transformations correspond to source code obfuscation transforms and the mathematical distance corresponds to a distance between a training-data point source code and additional data-points corresponding to potential malware code.

11. The method of claim 8, wherein the robustness evaluation of each of the first and second DNN models comprises a graph illustrating the robustness at the additional data-points of the realistic transformations.

12. The method of claim 8, wherein the robustness evaluation of each of the DNN models identify a particular class of an initial image classification where there are identified robustness holes.

13. The method of claim 7, the method further comprising recommending either the first or second DNN model for a particular application based which of the first DNN model or the second DNN model is identified as having greater robustness.

14. A non-transitory computer-readable storage medium configured to store instructions that, in response to being executed, cause a system to perform operations, the operations comprising:
obtaining a set of training data-points correctly predicted by the DNN model;
obtaining a set of realistic transformations of the set of training data-points correctly predicted by the DNN model, the set of realistic transformations corresponding to additional data-points within a predetermined mathematical distance from each of a training data-point of the set of training data-points;
creating a robustness profile corresponding to whether the DNN model accurately predicts an outcome for the additional data-points of the set of realistic transformations; and
generating a robustness evaluation of the DNN model based on the robustness profile.

15. The computer-readable storage medium of claim 14, wherein the operations further comprise:
identifying a plurality of robustness holes in the DNN model corresponding to additional data-points where the DNN model is determined as inaccurately predicting the outcome of the additional data-points.

16. The computer-readable storage medium of claim 15, wherein the DNN model is an image classification model and the predetermined mathematical distance is a L^{P}-norm used to measure a distance between two images by measuring the difference between two vectors in a given vector space.

17. The computer-readable storage medium of claim 14, wherein the DNN model is a malware detection model, wherein the robustness evaluation of the DNN model identifies a particular class of realistic transformations where there are identified robustness holes.

18. The computer-readable storage medium of claim 14, wherein the robustness evaluation of the DNN model comprises a graph illustrating the robustness at the additional data-points of the realistic transformations.

19. The computer-readable storage medium of claim 14, wherein the DNN model is a malware detection model, wherein the set of realistic transformations correspond to source code obfuscation transforms and the mathematical distance corresponds to a distance between a training-data point source code and additional data-points corresponding to potential malware code.
